(19) United States
(12) Patent Application Publication
(10) Pub. No.: US 2006/0039023 A1
(43) Pub. Date: Feb. 23, 2006

(54) Method and system for commercial processing of digital image files

(76) Inventors: John Russell Supra JR., Redondo Beach, CA (US); Jon Michael Moeller, Santa Monica, CA (US); Hugh Eric Milstein, Los Angeles, CA (US)

Correspondence Address: WHITE-WELKER & WELKER, LLC, P.O. BOX 199, CLEAR SPRING, MD, 21722-0199, US

(21) Appl. No.: 11/209,537

(22) Filed: Aug. 23, 2005

Related U.S. Application Data
(60) Provisional application No. 60/603,802, filed on Aug. 23, 2004.

(51) Int. Cl. G06F 3/12

(52) U.S. Cl. 358/1.13

(57) ABSTRACT

The method for bulk processing digital image files of the present invention utilizes a management control system that divides and distributes the processing of media files to two or more processing computers and then recombines the processed media files for use. The result of the present invention is that high and mid level photographers will be able to more quickly process raw digital images into standard image formats. Furthermore, additional image enhancements such as color correction, resizing/scaling or rotation during the processing can be applied resulting in faster access to and ability to make use of the captured media.

This application claims priority from U.S. Provisional Patent Application Ser. No. 60/603,802, entitled “Method and System for Commercial Processing of Digital Image Files”, filed on 23 Aug. 2004.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to the bulk processing of digital image files and more specifically to the processing of bulk digital image files generated by professional photographers and processed commercially.

### DEFINITION OF TERMS

Bulk Processing is the processing on a plurality of objects at one time or in an efficient manner to reduce processing costs.

Commercial Use includes any entity involved in the production, processing, or merchandising of a commodity.

An Electronic Media Device is any electric device used to receive, transmit, and store data such as cameras and their associate digital capture media, mobile phones, personal data assistants, and computers.

### BACKGROUND OF THE INVENTION

Typically, professional photographers still take pictures onto film and have them processed at a chemical lab. The chemical lab originally processed one roll of film at a time, and over time evolved to include the use of dip-n-dunk tanks that allow the processing of many rolls of film and even further evolved to machine-automated systems for processing even more rolls of film in a given period of time.

Technology advances in digital photography have made it possible for professional photographers to consider switching their work to a completely digital format. Coupled with additional benefits for a photographer's client including improved time to review images and ability to have images available via the Internet significant value is being placed on the move to digital photography for professional use in ways that maximize the value of digital content. These emerging technologies have not only enhance the processing and delivery of entertainment and digital content but can also reduce the cost of communication, increase market potential, create new and innovative products and services, protect assets and create efficiencies previously not considered achievable.

The current state of digital photography is like processing one roll of film at a time, for example, a single computer and operator moves files onto a computer and that computer processes each file one at a time. Although this is viable for home use and even individual professional photographers, the model does not scale to meet the professional commercial processing needs as more professionals move digital. Thus, it is one objective of the present invention to provide a replacement for the current digital lab through the ability to commercially bulk process digital images. One objective of the digital image processing system of the present invention is to enable high and mid level photographers to bulk process digital image files at much faster rates then currently available in the art. One result of the digital image processing system of the present invention is that high and mid level photographers will be able to more quickly process media files from cameras, camera-backs or other digital capture media to computers or other locations with the added benefit of providing additional optional image enhancements such as color correction, resizing/scaling or rotation during the processing resulting in a faster overall workflow.

Digital media consists of any audio, video, document, game or image in a digital format, as opposed to traditional analog media in the form of tapes, print, photos, art, etc. Digital media solutions known in the prior art include the software and infrastructure to create, manage, secure, distribute and consume digital media assets. These solutions span from consumer based viewing and consumption applications, media and entertainment company creation and deployment, to enterprise organization and delivery of media content as a means of asset tracking and verification, employee training, multi-media installation guides, or streamlining advertising practices and media content. These solutions are aimed at generating new business models, reducing risk in product or service deployments and developing sound business value.

Content in an analog format requires a process to be digitized. Other content may already be in a digital format, for example, digital photos, games or graphics. The process to digitize content requires the use of encoders, scanners or other capture techniques. Thus, the creation phase is rapidly shifting away from the analog format to the more efficient digital format, eliminating the labor-intensive step of converting analog content to a digital format.

There are a number of off-the-shelf solutions for converting analog content to digital content, however content creation via digital means has created a new set of inefficiencies. For example, the entire digital process of exporting, processing, distributing, converting, altering, and delivering digital image files must be a simplified, easy to use method that allows for bulk processing. The digital image processing system of the present invention solves these deficiencies found in the prior art with respect to the scaling problems of current hardware and software systems when bulk-processing media files. The digital image processing system of the present invention solves the distribution deficiencies found in the prior art by utilizing a node based computer system for the bulk processing of digital image files.

An image management unit is utilized to distribute images over a plurality of image processing devices to ensure the most time effective processing of the bulk digital image files and then recombines the processed media files for later use or retrieval. In this section of processing, individual media files are not split, but all the individual media files that make up a “shoot” or job” are split based on individual images or frames. Thus, the plurality of individual media files comprising the “shoot” or “job” are split and distributed for processing.

Technologies, as well as strategies for distributing digital content continue to emerge. Recent trends are moving away from streaming technologies to a download or semi-download model. Elaborate caching techniques, both on the client and server are allowing high quality files to be distributed using more standard and prevalent protocols. This is helping companies control their costs better which is subsequently leading to more profitable business models. The digital image processing system of the present invention solves the distribution deficiencies found in the prior art by utilizing the efficiencies found in the node based computer system for the processing of bulk digital image files.

A job control unit is used to transfer the standard format images generated by each node-processing computer by recombining the processed media files for later use or retrieval to a local or remote storage system. Again, the present invention is not as interested in the mere distribution or moving of files from a media device as it is the processing of individual medial files from an initial raw state in to standard image format.

The management control system of the present invention is currently being utilized for digital animation in the movie industry and other systems have illustrated the increased processing ability of a node computer system as required by the present invention to obtain the increase in media file processing. At this time, the state of the art does not include such processing for still photography and current software does not support the scaling problems associated with the processing bulk media files solved by the present invention.

### SUMMARY OF THE INVENTION

The invention, in its preferred embodiment, consists of a method and process for commercial processing of digital image files. The object of the present invention is to enable high and mid level photographers to bulk process digital image files at much faster rate then currently available in the art. The present invention utilizes a management control system that divides and distributes the bulk media files to two or more processing computers and then incorporates a job control unit to recombine the processed media files for storage on a local or remote system for later use or retrieval.

The management control system is comprised of a job control unit and image management unit. The job control unit's functions are to acquire the bulk image files desired for processing and prepare them for processing and delivery to the image management unit. The image management unit then proceeds to distribute images over the node base computer system for processing. In the present invention there are two operation methods for controlling the image management unit. In a first operational mode, the image management unit proceeds to distribute images while maintaining a record of queue size for each processing system and sub-set of bulk files. In a second operational mode, the image management unit proceeds to distribute images over n-available processing nodes and simply sends each of n-available nodes one image when the node is free or available for process while the remainder of the images wait in the job control unit until a free resource node is available.

Once processing is complete the job control unit receives the standard format files and delivers them to a requested location that may be a local or remote storage system.

The result of the present invention is that high and mid level photographers will be able to more quickly to process raw media files into a standard image media file with the added benefit of providing additional optional image enhancements such as color correction, resizing/scaling or rotation resulting in the faster access to and ability to make use of the captured media.

### BRIEF DESCRIPTION OF THE DRAWINGS

FIG. 1 illustrates the major elements of the image processing system of the present invention;

FIG. 2 illustrates the job control system of the present invention;

FIG. 3 illustrates the image processing system of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is an improved image processing method which enables high and mid level photographers to more quickly process media files from cameras, camera-backs or other digital capture media with the added benefit of providing additional optional image enhancements such as color correction, resizing/scaling or rotation during the processing resulting in the faster access to and ability to make use of the captured media.

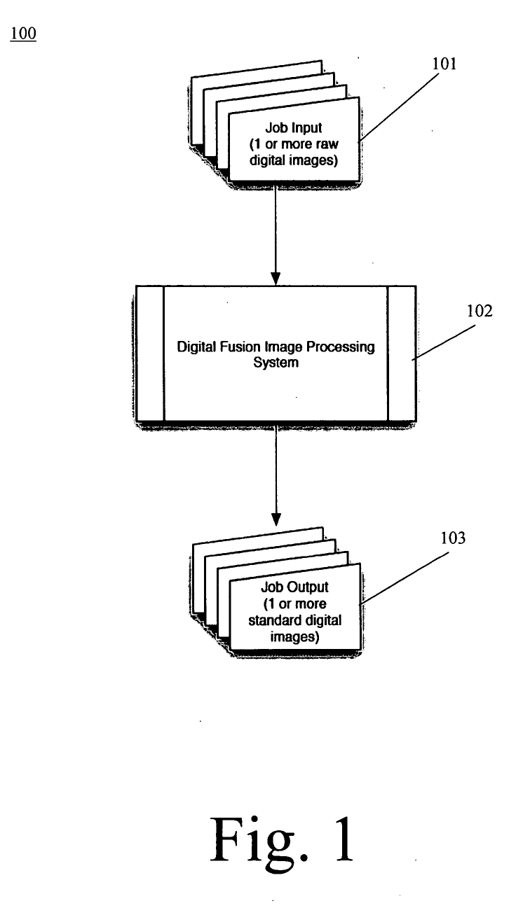

The major elements of the digital image processing system 100, as illustrated in FIG. 1, consist of the job input 101 of one or more raw digital images files, processing system 102, and the job output 103. The job input system typically receives digital image files from electronic media devices such as cameras and their associate digital capture media, mobile phones, personal data assistants, and computers. In a preferred embodiment of the image processing system 100 of the present invention system operators or high and mid level photographers would input digital image files directly from their cameras and computers or through the use of portable storage devices that would be compatible with the job input system. The processing system 102 would then transform the raw digital image files of the job input 101 into the standard format digital image files of the job output 103.

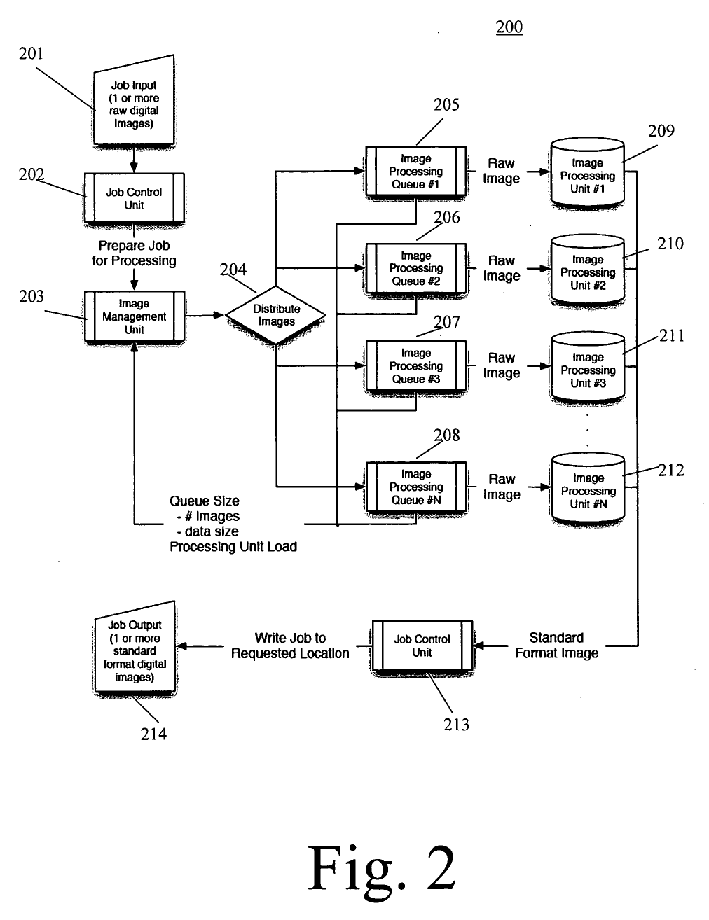

Now referring to FIG. 2 the job control system 200 of the digital image processing system 100 of the present invention is described. The job control unit 202 initially receives a job input 201 consisting of one or more raw digital image files and begins to prepare the job for processing. Once preparations are complete the job control unit 202 sends the information to the image management unit 203 for image distribution 204 through one or more image queues 205, 206, 207, and 208. Once the distribution of images has been completed the image queues 205, 206, 207, and 208 notify the image management unit 203 of their respective queue sizes by providing such information as the number of images, data size, and processing unit load of their respective queue.

In an alternative embodiment or in a situation where the queue size is equal to zero, the image management unit 203 can simply send jobs to available image processing units 209, 210, 211, and 212 when they are available for processing.

Raw image files are then made available to all the image queues 205, 206, 207, and 208 to corresponding image processing units 209, 210, 211, and 212. The image processing units 209, 210, 211, and 212 can perform any number of functions such as color correction, resizing, rotating or retouching. Upon completing of the desired processing functions, the image processing units 209, 210, 211, and 212 output standard format image files that are then sent to the job control unit 213. The job control unit's 213 final function is then to write to a requested location the job output 214 which consists of one or more standard digital image files. The job control unit 213 has the ability to transfer the job output to any storage device, a local computer, to another computer or storage device connected to a computer network such as the Internet.

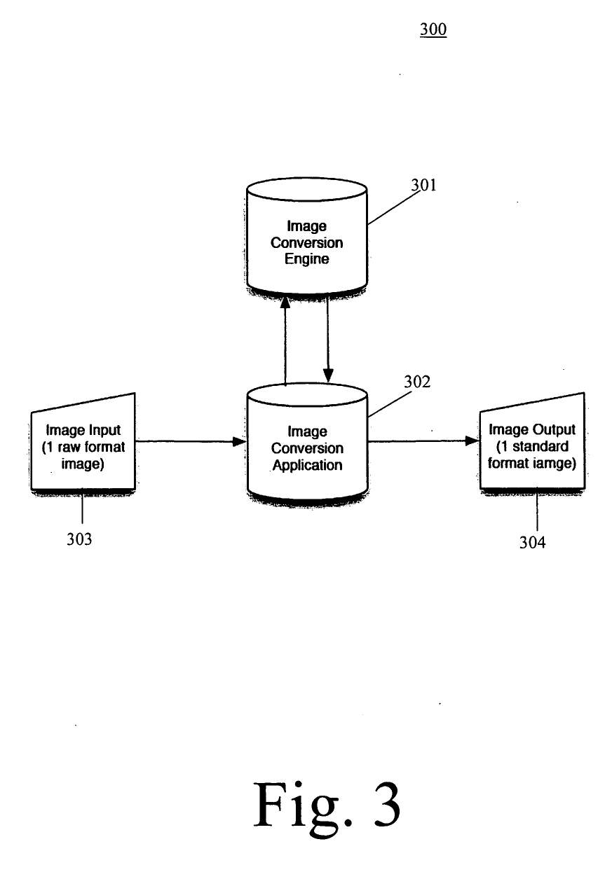

The image-processing unit 300 of the present invention is further described in FIG. 3. The image processing unit 300 comprises an image conversion application 302 which is a novel component of the digital image processing system 100 of the present invention that calls the appropriate image conversion engine 301 based upon the type of raw image input data 303 and desired standard format output 304. The image conversion engine 301 may be a 3^{rd} party or customer engine that does the actual file conversion from raw image input data 303 to the desired standard format output 304 and returns the result to the image conversion application 302.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. Method for processing digital image files comprising the following means and functions:
(a) a job control unit for the preparation of job processing;
(b) a job input to said job control unit of one or more raw digital images;
(c) an image management unit for determining the image distributions over one or more image processing queues;
(d) one or more image processing units wherein said image processing units transform said raw images into a standard format image;
(e) said image processing unit's loads controlled by said image management unit; and
(f) a job control unit for writing job files in said standard format image to a requested location.

2. The method for processing digital image files of claim 1 wherein the job input system receives digital image files from an electronic media device.

3. The method for processing digital image files of claim 2 wherein a photographer or system operator inputs digital image files directly from an electronic media device.

4. The method for processing digital image files of claim 2 wherein a photographer through the use of a portable electronic media storage device.

5. The method for processing digital image files of claim 1 wherein the image processing units further comprising an image conversion application and an image conversion engine.

6. The method for processing digital image files of claim 5 wherein the image processing unit the image conversion application calls the appropriate image conversion engine based upon the type of raw image input data and desired standard format output.

7. The method for processing digital image files of claim 6 wherein the image conversion engine performs the actual file conversion from raw image input data to the desired standard format output and returns the result to the image conversion application.

8. Process of processing digital image files comprising the following steps:
(a) a job control unit initially receives a job input consisting of one or more raw digital image files;
(b) said job control unit begins to prepare the job for processing;
(c) once said preparations are complete, the job control unit sends the information to an image management unit for image distribution;
(d) said image distribution occurs through one or more image queues;
(e) once the distribution of images has been completed;
(f) are then assigned by the image queues to and accessed by a corresponding image processing units for processing;
the image management unit proceeds to distribute raw image files over one or more available processing queues and sends each image queue one image when the queue and its corresponding image processing unit are free or available for process while the remainder of the images wait in the job control unit until a free resource image processing unit is available;
(g) upon completion of the processing functions, the image processing units convert the raw image files into standard format image files that can then be accessed by the job control unit; and
(h) the job control unit's final function is to write to a requested location the job output, which consists of one or more standard digital image files.

9. The process of processing digital image files of claim 8 wherein the image queues notify the image management unit of their respective queue sizes by providing:
the number of images,
data size,
and processing unit load of their respective queue.

10. The process of processing digital image files of claim 8 wherein the functions of said image processing units include image enhancement and modification.

11. The process of processing digital image files of claim 8 wherein he job control unit transfers the job output to any storage device, a local computer, or to another computer or storage device connected to a multi-user computer network.

12. The process of processing digital image files of claim 8 wherein the image processing units further comprising an image conversion application and an image conversion engine.

13. The process of processing digital image files of claim 12 wherein the image processing unit the image conversion application calls the appropriate image conversion engine based upon the type of raw image input data and desired standard format output.

14. The process of processing digital image files of claim 13 wherein the image conversion engine performs the actual file conversion from raw image input data to the desired standard format output and returns the result to the image conversion application.

15. The method for processing digital image files of claim 1 wherein said image management unit controls queue size.
